(19) United States
(12) Patent Application Publication
(10) Pub. No.: US 2022/0264978 A1
(43) Pub. Date: Aug. 25, 2022

(54) One-piece sandwich structured knitted waterproof shoe upper with rubber topline

(71) Applicant: Baohong Cao, Lu'an City (CN)

(72) Inventor: Baohong Cao, Lu'an City (CN)

(21) Appl. No.: 17/231,061

(22) Filed: Apr. 15, 2021

(30) Foreign Application Priority Data
Feb. 20, 2021 (CN) 2021203814863

(51) Int. Cl. A41D 31/102; B32B 5/02; A43B 21/02

(52) U.S. Cl. CPC A41D 31/102; B32B 5/026; A43B 21/02; B32B 2437/00; B32B 2307/724

(57) ABSTRACT

The present invention discloses a novel one-piece sandwich structured knitted waterproof upper with rubber topline, comprises, an upper body, comprising a surface layer, a waterproof and breathing layer and a liner layer, the surface layer is made from yarn, an inner side of the surface layer is provided with evenly distributed yarn meshes, the liner layer is made from a polyester fiber layer, an inner side of the polyester fiber layer is provided with a mildew proof and antibacterial layer; an end of the upper body is provided with a topline, a flexible rubber band is provided at an inner side of the topline; and ventilating pores are provided at an inner side of the surface layer. By configuring the upper body to contain materials such as the polyester fiber layer with waterproof function and cooperating with weaving in different knitting intensities, air ventilation is good compared with leather uppers.

### TECHNICAL FIELD

The present invention relates to shoe upper technology, especially to a novel one-piece sandwich structured knitted waterproof shoe upper with rubber topline.

### BACKGROUND TECHNOLOGY

With improvement of all aspects of the society, people put more and more emphasis on living standards and personal pleasure, and people pay particular attention on comfort, especially wearing comfort. Shoes are worn for protecting feet against injuries, and in an early phase of human civilization, shoes are primarily straw sandals and cloth shoes, currently leather shoes, sport shoes and leisure shoes are quite common to see, and high demands are on the uppers when fabricating shoes. Meanwhile, when the uppers are made from cloth or textile materials, although sweat and moisture exudates from the feet can be discharged effectively, foreign water cannot be prevented from permeating inside, and functions of conventional uppers are few, which cannot satisfy requirements from the wearers on wearing comfort, and affect wearing experience.

Upon search, it is found that a Chinese utility model application number CN2019220191207 has disclosed a breathable and waterproof upper, comprising a surface layer, and intermediate layer and a bottom layer, a plurality of ventilation pores are provided on the surface layer, absorption blocks are provided in the intermediate layer, hollow cavities are provided in the intermediate layer, strengthening strips are provided on both sides of the absorption blocks, inside the strengthening strips are provided air ventilation passage, through-hole rings are provided at connection between the absorption blocks and the air ventilation passage and air guiding pores are provided at connection between the bottom layer and the air ventilation passage. There are following disadvantages with the breathable and waterproof uppers provided in the abovementioned application: the uppers demand manual knitting with a sewing machine, which consumes manpower and materials greatly.

### SUMMARY OF THE INVENTION

The present invention provides a novel one-piece sandwich structured knitted waterproof shoe upper with rubber topline to address deficiencies existing in the prior art.

To realize the foregoing target, the present invention adopts the following technical solution: A novel one-piece sandwich structured knitted waterproof upper with rubber topline, comprises, an upper body, which comprises a surface layer, a waterproof and breathing layer and a liner layer, the surface layer is made from yarn, an inner side of the surface layer is provided with evenly distributed yarn meshes, the liner layer is made from a polyester fiber layer, an inner side of the polyester fiber layer is provided with a mildew proof and antibacterial layer; and an end of the upper body is provided with a topline, and a flexible rubber band is provided at an inner side of the topline.

As a further solution of the present invention: ventilating pores are provided at an inner side of the surface layer.

As another further solution of the present invention: an elastic layer is respectively provided at a top part and a bottom part of the inner side of the surface layer, a flexible supporting frame is respectively provided in inner sides of both the elastic layers, and a single set of tensioning bracings is provided between a bottom side and a top side of both the elastic layers.

As a further solution of the present invention: dust discharging openings are provided in both sides of an outer wall of the upper body.

As another further solution of the present invention: the waterproof and breathing layer comprises a breathing and waterproof film and an insulation layer.

As a further solution of the present invention: at least four rubber posts are provided at an outer wall of a top part of the upper body.

As another further solution of the present invention: a cushioning pad is provided at the outer wall of the top part of the upper; and an abrasion resistant block is provided at an outer wall of a top part of the cushioning pad.

Compared with the prior art, the present invention provides a novel one-piece sandwich structured knitted waterproof upper with rubber topline, which has the following beneficial effects:
1. In the novel one-piece sandwich structured knitted waterproof shoe upper with removable rubber topline, the upper body is made to be one-piece by weaving, the liner layer consisted of the polyester fiber layer and the mildew proof and antibacterial layer will achieve internally moisture absorption, odor removal and bacteria killing and externally waterproof effects, by configuring the upper body to contain materials such as the polyester fiber layer with a waterproof function and cooperating with weaving in different knitting intensities, air ventilation is good compared with leather uppers; and the entire shoe upper body is woven to be one-piece, eliminating needs for a sewing machine to knit, which will consequently save a lot of manpower and materials compared to conventional leather shoes.
2. In the novel one-piece sandwich structured knitted waterproof shoe upper with removable rubber topline, the breathing and waterproof film serves to block foreign water from entering and wetting the liner layer; as most of the upper bodies are made by weaving, and yarn meshes are formed in surface of the surface layer, while air ventilation is good, dust is liable to enter, by providing the insulation layer, dust is successfully blocked; and as the upper body appears to be of an arc shape, the blocked dust will slide along the insulation layer until the dust discharging openings and be discharged therefrom, which avoids confinement of dust in the upper body and prevents the surface layer being jammed.
3. In the novel one-piece sandwich structured knitted waterproof shoe upper with rubber topline, when wearing, the flexible rubber band can adjust the topline according to different sizes of the ankles, which is done automatically, to improve wearing comfort of the upper body; the flexible supporting frames support both the elastic layers, which increases flexible buffer capacity of the surface layer, and in the meantime, reduces possibility of deformation of the upper body due to long wearing time; and by rubbing and moving the set of tensioning bracings from both ends of the upper body, tensioning degree of the surface layer can be adjusted, so as to expand or shrink the upper body as per different foot sizes, which further enhances wearing comfort; and heat or odor generated during wearing is disseminated via the ventilation pores to the yarn meshes, which has greatly improved air ventilation property of the upper body in all directions compared with upper bodies of other configurations, and consequently further improves wearing comfort.
4. In the novel one-piece sandwich structured knitted waterproof shoe upper with rubber topline, the cushioning pad and the rubber posts work to mitigate shock when a foreign subject hits the shoes, which will reduce possibility of foot injuries; and the abrasion resistant block serves to increase abrasion resistance property of the toe cap, which will elongate service life of the upper body.

### BRIEF DESCRIPTION OF THE DRAWINGS

FIG. 1 is a structural top view of the novel one-piece sandwich structured knitted waterproof shoe upper with rubber topline proposed by the present invention;

FIG. 2 is a structural cross sectional diagram of a rear side of the novel one-piece sandwich structured knitted waterproof shoe upper with rubber topline;

FIG. 3 is a structural cross sectional diagram of a front side of an upper body in the novel one-piece sandwich structured knitted waterproof shoe upper with rubber topline according to the present invention; and

FIG. 4 is a structural cross sectional diagram of a left side of an upper body in the novel one-piece sandwich structured knitted waterproof shoe upper with rubber topline according to the present invention.

### EMBODIMENTS

Hereinafter a clear and complete description will be given to technical solutions in embodiments of the present invention in conjunction with accompanying drawings of embodiments of the present invention and apparently, the given embodiments are only some of embodiments of the present invention rather than all.

In description of the present invention, it shall be understood that, orientation or position relationships indicated by terms such as “upper”, “lower”, “front”, “rear”, “left”, “right”, “top”, “bottom”, “inner” and “outer” are based on the accompanying drawings, only for convenience and simplification of description of the present invention, rather than indicating or meaning that the devices or components must be in a particular orientation, or manufactured or operated in a particular orientation, and consequently cannot be comprehended as limitation to the present invention.

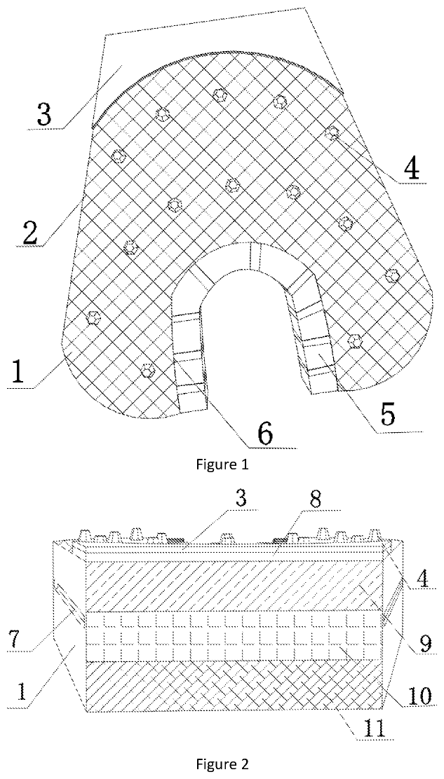

A novel one-piece sandwich structure knitted waterproof shoe upper with rubber topline, for saving fabrication cost of the upper body 1, as shown in FIG. 1 to FIG. 4, comprising an upper body 1, the upper body 1 comprises a surface layer 9, a waterproof and breathing layer 10 and a liner layer 11; the surface layer 9 is woven with yarn, evenly distributed yarn meshes 2 are provided at an inner side of the surface layer 9; the liner layer 11 is woven from a polyester fiber layer 17, and a mildew proof and antibacterial layer 18 is provided at an inner side of the polyester fiber layer 17; one end of the upper body 1 is provided with a topline 6, a flexible rubber 5 is crocheted at an inner side of the topline 6; the upper body 1 is made by weaving process, during fabrication, firstly, knitting a plain rib stitch with the polyester fiber layer 17 with mildew proof and antibacterial functions; after weaving the liner layer 11 underneath, taking a flexible rubber band 5 woven by 1*1 ribbing as an elastic topline 6, which also serves to transit and connect the surface layer 9, after knitting the topline, transiting with full needle rib, and weaving the uppermost surface layer 9 of the upper body 1; after weaving the surface layer 9, cutting a fitting waterproof and breathing layer 10 and embedding the same between the liner layer 11 and the surface layer 9, steaming and heating at a rotation speed of 40 m/s and temperature of 100° C. to 110° C., to bond the liner layer 11, the waterproof and breathing layer 10 and the surface layer 9 together and form an integral upper body; by providing an elastic topline 5, it is possible to adjust the topline 5 according to different sizes of the ankles automatically, to improve wearing comfort of the upper body 1; the liner layer made from the polyester fiber layer 17 and the mildew proof and antibacterial layer 18 works to internally absorb moisture, remove odor, and kill bacteria, and externally damp water; the upper body 1 is made from materials such as the polyester fiber layer 17 with a waterproof function, cooperating with different knitting densities, a good air ventilation effect can be achieved compared with leather uppers; and the entire plain knitted upper body is knitted to be one-piece, which makes it unnecessary to use a sewing machine to stitch and compared with traditional leather shoes, manpower and material costs can be saved significantly.

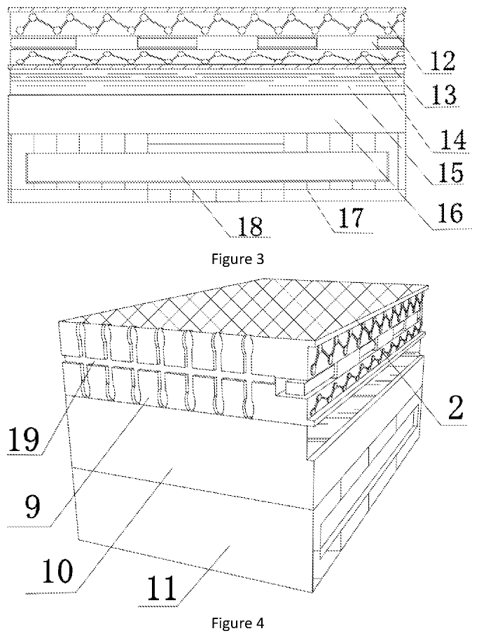

To improve air ventilation property of the upper body 1, as shown in FIG. 3 and FIG. 4, at the inner side of the surface layer 9 are provided ventilation pores 19, an elastic layer 12 is respectively provided at a top part and a bottom part of the inner side of the surface layer 9, flexible supporting frames 14 are provided in inner sides of both elastic layers 12, and a single set of tensioning bracings 13 is provided between a bottom side and a top side of both the elastic layers 12; during wearing, the flexible supporting frames 14 supports the two elastic layers 12, which increases elasticity and cushioning ability of the surface layer 9, in the meanwhile, reduces possibility of deformation of the upper body 1 due to long wearing time; by rubbing and moving the set of tensioning bracings 13 from both ends of the upper body 1, tensioning degree of the surface layer 9 can be adjusted, so as to enlarge or shrink the upper body 1 as per different foot sizes, and enhances wearing comfort, and heat or odor generated during wearing will be disseminated from the ventilation pores 19 to the yarn meshes 2, and compared with upper bodies 1 of other configurations, air ventilation property and wearing comfort of the upper body 1 is greatly improved.

To avoid dust detention in the upper body 1, as shown in FIG. 2 and FIG. 3, dust discharging openings 7 are provided on an outer wall of both sides of the upper body 1, the waterproof and breathing layer 10 comprises a breathing and waterproof film 16 and an insulation layer 15, the breathing and waterproof film 16 blocks foreign water from entering and wetting the liner layer 11, and as the upper body 1 is usually made by weaving process, and yarn meshes 2 are provided in the surface layer for air dissemination, while air ventilation is good, dust is liable to enter, by providing the insulation layer 15, the dust can be blocked, and as the upper body 1 appears to be of an arc shape during wearing, blocked dust slides along the insulation layer 15 to the dust discharging openings 7, and is discharged therefrom, which avoids retention of dust in the upper body 1 and consequent jamming of the surface layer 9.

To prolong service life of the upper body 1, as shown in FIG. 1 and FIG. 2, at least four rubber posts 4 are connected to an outer wall of a top part of the upper body 1, a cushioning pad 8 is connected to the outer wall of the top part of the upper body 1, and an abrasion resistant block 3 is connected to an outer wall of a top part of the cushioning pad 8; during wearing, the cushioning pad 8 and the rubber posts 4 serve to damp shock when a foreign object hits the shoe, and lowers possibility of foot injuries; and the abrasion resistant block 3 will increase abrasion resistant property of the toe cap and prolong service life of the upper body 1.

Working principles: the upper body 1 is made by weaving process, firstly, knitting a plain rib stitch with the polyester fiber layer 17 with mildew proof and antibacterial functions; after weaving the liner layer 11 underneath, taking a flexible rubber band 5 woven by 1*1 ribbing as an elastic topline 6, which also serves to transit and connect the surface layer 9, after knitting the topline, transiting with full needle rib, and weaving the uppermost surface layer 9 of the upper body 1; after weaving the surface layer 9, cutting a fitting waterproof and breathing layer 10 and embedding the same between the liner layer 11 and the surface layer 9, steaming and heating at a rotation speed of 40 m/s and temperature of 100° C. to 110° C., to bond the liner layer 11, the waterproof and breathing layer 10 and the surface layer 9 together and form an integral upper body; by providing an elastic topline 5, it is possible to adjust the topline 5 according to different sizes of the ankles automatically, to improve wearing comfort of the upper body 1; the liner layer made from the polyester fiber layer 17 and the mildew proof and antibacterial layer 18 works to internally absorb moisture, remove odor, and kill bacteria, and externally damp water; the upper body 1 is made from materials such as the polyester fiber layer 17 with a waterproof function, cooperating with different knitting densities, a good air ventilation effect can be achieved compared with leather uppers; and the entire plain knitted upper body is knitted to be one-piece, which makes it unnecessary to use a sewing machine to stitch and compared with traditional leather shoes, manpower and material costs can be saved significantly; during wearing, the flexible supporting frames 14 supports the two elastic layers 12, which increases elasticity and cushioning ability of the surface layer 9, in the meanwhile, reduces possibility of deformation of the upper body 1 due to long wearing time; by rubbing and moving the set of tensioning bracings 13 from both ends of the upper body 1, tensioning degree of the surface layer 9 can be adjusted, so as to enlarge or shrink the upper body 1 as per different foot sizes, and enhances wearing comfort, and heat or odor generated during wearing will be disseminated from the ventilation pores 19 to the yarn meshes 2, and compared with upper bodies 1 of other configurations, air ventilation property and wearing comfort of the upper body 1 is greatly improved; during wearing, the flexible supporting frames 14 supports the two elastic layers 12, which increases elasticity and cushioning ability of the surface layer 9, in the meanwhile, reduces possibility of deformation of the upper body 1 due to long wearing time; by rubbing and moving the set of tensioning bracings 13 from both ends of the upper body 1, tensioning degree of the surface layer 9 can be adjusted, so as to enlarge or shrink the upper body 1 as per different foot sizes, and enhances wearing comfort, and heat or odor generated during wearing will be disseminated from the ventilation pores 19 to the yarn meshes 2, and compared with upper bodies 1 of other configurations, air ventilation property and wearing comfort of the upper body 1 is greatly improved; and during wearing, the cushioning pad 8 and the rubber posts 4 serve to damp shock when a foreign object hits the shoe, and lowers possibility of foot injuries; and the abrasion resistant block 3 will increase abrasion resistant property of the toe cap and prolong service life of the upper body 1.

The foregoing are some preferred embodiments of the present invention, but the scope of the present invention is not limited by these preferred embodiments, any equivalent replacement and modifications made by those skilled in the art within the technical scope disclosed by the present invention according to the technical solution of the present invention and spirits thereof shall be covered in the protection scope of the present invention.

We claim:

1. A novel one-piece sandwich structured knitted waterproof upper with rubber topline, characterized in that, comprising, an upper body (1), which comprises a surface layer (9), a waterproof and breathing layer (10) and a liner layer (11), the surface layer (9) is made from yarn, an inner side of the surface layer (9) is provided with evenly distributed yarn meshes (2), the liner layer (11) is made from a polyester fiber layer (17), an inner side of the polyester fiber layer (17) is provided with a mildew proof and antibacterial layer (18); and an end of the upper body (1) is provided with a topline (6), and a flexible rubber band (5) is provided at an inner side of the topline (6).

2. The novel one-piece sandwich structured knitted waterproof upper with rubber topline according to claim 1, characterized in that, ventilating pores (19) are provided at an inner side of the surface layer (9).

3. The novel one-piece sandwich structured knitted waterproof upper with rubber topline according to claim 2, characterized in that, an elastic layer (12) is respectively provided at a top part and a bottom part of the inner side of the surface layer (9), a flexible supporting frame (14) is respectively provided in inner sides of both the elastic layers (12), and a single set of tensioning bracings (13) is provided between a bottom side and a top side of both the elastic layers (12).

4. The novel one-piece sandwich structured knitted waterproof upper with rubber topline according to claim 3, characterized in that, dust discharging openings (7) are provided in both sides of an outer wall of the upper body (1).

5. The novel one-piece sandwich structured knitted waterproof upper with rubber topline according to claim 4, characterized in that, the waterproof and breathing layer (10) comprises a breathing and waterproof film (16) and an insulation layer (15).

6. The novel one-piece sandwich structured knitted waterproof upper with rubber topline according to claim 1, characterized in that, at least four rubber posts (4) are provided at an outer wall of a top part of the upper body (1).

7. The novel one-piece sandwich structured knitted waterproof upper with rubber topline according to claim 6, characterized in that, a cushioning pad (8) is provided at the outer wall of the top part of the upper (1); and an abrasion resistant block (3) is provided at an outer wall of a top part of the cushioning pad (3).
